(19) United States
(12) Patent Application Publication
(10) Pub. No.: US 2003/0205851 A1
(43) Pub. Date: Nov. 6, 2003

(54) Device and method for producing freely formed products

(75) Inventors: Helmut Laschutza, Ritterhude (DE); Frank Hagemeister, Bremen (DE)

Correspondence Address: ALTERA LAW GROUP, LLC, 6500 CITY WEST PARKWAY, SUITE 100, MINNEAPOLIS, MN, 55344-7704, US

(73) Assignee: BEGO Medical AG, Bremen (DE)

(21) Appl. No.: 10/426,358

(22) Filed: Apr. 30, 2003

(30) Foreign Application Priority Data
May 3, 2002 (DE) 102 19 984.1

(51) Int. Cl. B29C 41/22

(52) U.S. Cl. 264/496; 264/113; 425/174

(57) ABSTRACT

A device for producing freely formed products through a buildup of layers of powder-form material that is solidified according to specification, comprises a (relatively) lowerable table on the one hand, and a powder feed above the table, a distribution device that spreads the powder in a predetermined thickness over the table, and an energy source that solidifies the powder of each layer on the other hand, that are horizontally movable with respect to each other. In particular, the horizontal movement of the table consists in a rotational movement around an vertical axis, which movement is combined with the descending movement into a spiral movement having a pitch corresponding to the layer thickness, the powder feed, the distribution device, and the energy source being arranged radially around the axis and being continuously active.

The invention relates to a device for producing freely formed products through a buildup of layers of powder-form material that is solidified according to specification, said device comprising a table that can be lowered in a relative manner, a powder feed above the table, a distribution device to spread the powder in a predetermined layer thickness above the table, and an energy source that partially solidifies the powder of each layer. The invention also relates to a corresponding method.

A device of the above type is known, for example, from U.S. Pat. No. 4,863,538. It serves the manufacturing of individually formed products without requiring the time-consuming and costly making of models. Thus, the method carried out with this device is frequently referred to as “rapid prototyping”.

With the known devices of the type described in the opening paragraph, that method can be carried out only in an intermittent manner: First, the material required for the next layer in each case is delivered by the powder feed and then distributed by the distribution device over the work surface to uniform layer thickness, and finally the energy source is moved over the entire work surface, before this sequence of steps is begun anew for the next layer. Since the costly components of the known devices are used only discontinuously with a temporal interval in each case, their capacity is only partially utilized; moreover, the secondary processing times required between the individual steps of the method are considerable.

The invention is based on the task of better utilizing the capacity of the device unit and, in particular, achieving a continuous process operation.

The device aspect of the invention accomplishes this task in that the table on the one hand, and the powder feed, the distribution device as well as the energy source on the other hand, are horizontally movable relative to each other. By this means, several tables can be processed one after another by the same components, and it is possible, for example, that on one table the solidifying of the last-applied powder layer is occurring at the same time that such a layer is being applied to a neighboring table.

According to a preferred further development of the invention, the horizontal movement of the table consists in a rotational movement around a vertical axis, and the powder feed, the distribution device, and the energy source are arranged radially around the axis. By means of such a device an uninterrupted construction of the products can be executed; preferably, the enlarging of the distance between the table and the unit thus necessary is achieved in that the table is lowered and the descending and rotational movements of the table are combined into a spiral movement with a pitch corresponding to the layer thickness, with the powder feed, the distribution device, and the energy source being continuously active.

The corresponding method for producing freely formed products from powder-form material, in which the powder is applied in vertically-sequential layers to a substrate, is uniformly distributed, and partially solidified according to specification, is distinguished by the fact that the powder is applied in a continuous layer around the center of a circle in a spiral manner, is distributed, and is partially solidified.

The invention is illustrated using two embodiment examples represented in the drawings. These show:

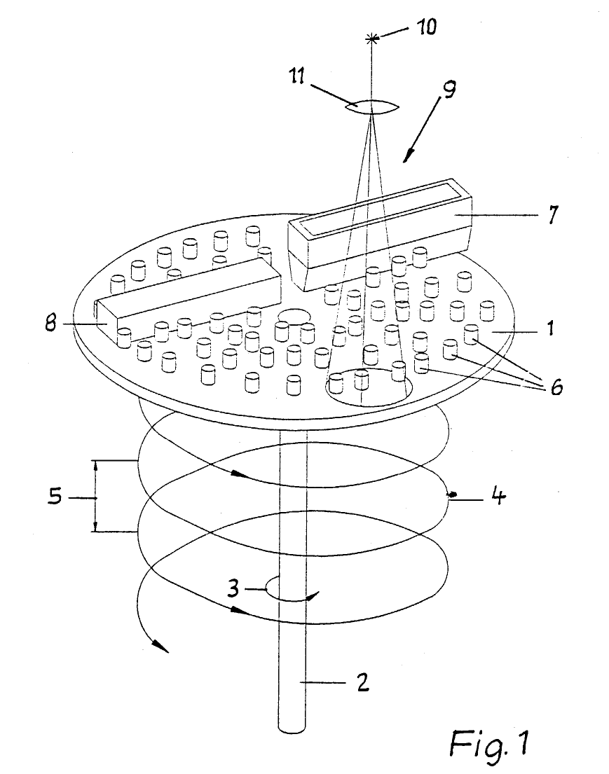

FIG. 1: a rotating table for producing small-part products, for example, dental products, in a schematic perspective representation

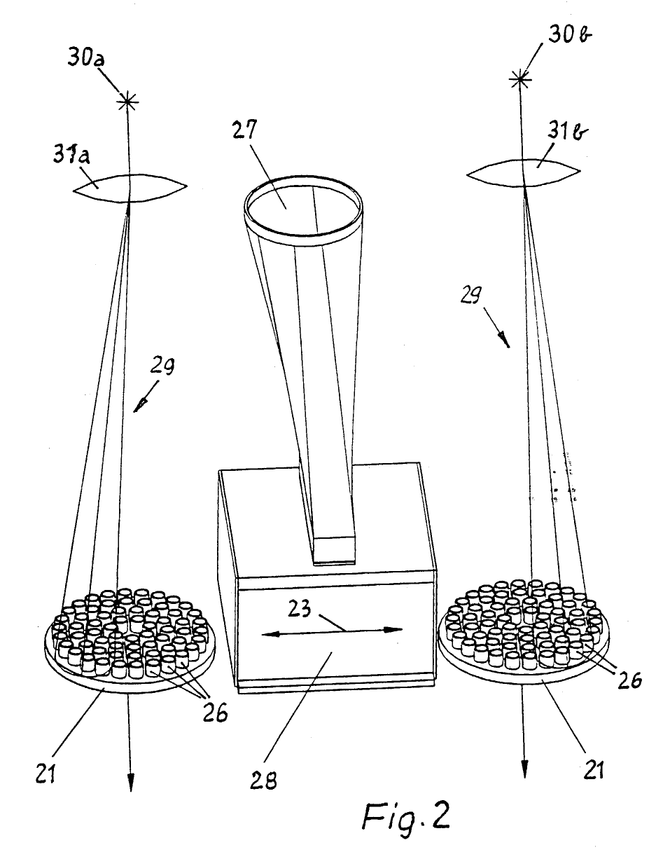

FIG. 2: a device with several tables, likewise in schematic perspective representation

In the embodiment example in FIG. 1, the table 1 is rotatable around the rotational axis 2 in the direction of the arrow 3. Furthermore, the table is lowerable in the direction of the axis 2, so that with a simultaneous rotation and sinking, each radius of its surface executes a spiral movement according to the spiral line 4 having an arrow. The pitch 5 of this spiral movement corresponds to the layer thickness of the layer of powder-form work material to be applied to the table for the products 6 to be made.

Above the table, the components necessary for carrying out the production process are arranged such that they pass over the entire surface in the course of one rotation of the table. Passing over first is the powder feed 7, which delivers the powder-form raw material for the product to the table. Next is the distribution device 8, which ensures a uniform thickness of the powder layer, and finally the energy source 9, which is represented here as the beam of a laser 10 that is directed by optics 11 sequentially onto the individual regions of the surface of the table 1 and thus onto the powder coat situated on the latter. The schematic drawing shows the powder feed 7 and the distribution device 8 next to the finished products 6 after the removal of excess powder material; it goes without saying that the components 7 and 8 are located above the products 6 when the latter are completed and the table 1 has concluded its spiral rotating and descending movement.

The embodiment form in FIG. 2 has two tables spaced apart horizontally, which spacing is shown in an enlarged manner. The tables 21 are arranged in a stationary manner at equal heights, and a powder feed 27 with connected distribution device 28 is movable horizontally in the direction of the arrow 23, so that it is situated over the one table 21 at one time, and over the other at another time.

While the powder feed and distribution device 27, 28 are located over the one table 21, on the other table 21 the partial solidification of the previously-applied powder layer takes place. In the example, this takes place with the aid of two laser beams 30a and 30b and optics 31a and 31b; however, it is also possible to use only one laser 30, the beam of which is optically directed now to one table 21, now to the other table 21, upon which (similar to the previous example) are shown small-part products 26 in more or less completed form.

1. Device for producing freely formed products through a buildup of layers of powder-form material that is solidified according to specification, comprising a table (1; 21) that can be lowered in a relative manner, a powder feed (7; 27) above the table, a distribution device (8; 28) that spreads the powder in a predetermined layer thickness over the table, and an energy source (10; 30) that partially solidifies the powder of each layer, characterized in that the table (1; 21) on the one hand, and the powder feed (7; 27), the distribution device (8; 28) as well as the energy source (10; 30) on the other hand, are horizontally movable relative to each other.

2. Device according to claim 1, characterized in that the horizontal movement of the table (1) consists in a rotational movement around a vertical axis (2) and the powder feed (7), the distribution device (8) and the energy source (10) are arranged radially around the axis (2).

3. Device according to claim 2, characterized in that the descending movement and the rotational movement are combined into a spiral movement (4) having a pitch (5) corresponding to the layer thickness, and the powder feed (7), the distribution device (8) as well as the energy source (10) are continuously active.

4. Device according to claim 1, characterized in that at least two tables (21) are arranged next to each other, and the powder feed (27), the distribution device (28) as well as the energy source (30) are movable in sequence over the tables.

5. Method for producing freely formed products from powder-form material, in which method the powder is applied to a substrate in vertically-sequential layers, is uniformly distributed, and partially solidified according to specification, characterized in that the powder is applied in a continuous layer around the center of a circle, is distributed, and is partially solidified.
